(19) United States
(12) Patent Application Publication
(10) Pub. No.: US 2025/0299577 A1
(43) Pub. Date: Sep. 25, 2025

(54) METHOD FOR PROVIDING ALARM OF FLOODED UNDERPASS BASED ON WATER LEVEL MEASUREMENT AND VEHICLE MOVEMENT ANALYSIS

(71) Applicant: NATIONAL DISASTER MANAGEMENT RESEARCH INSTITUTE, Ulsan (KR)

(72) Inventors: SEUNG HO YANG, Ulsan (KR); YEON JU KIM, Ulsan (KR); EUN BYUL KIM, Ulsan (KR); SENG YONG CHOI, Ulsan (KR); CHEOL KYU LEE, Ulsan (KR); JIN EUN KIM, Ulsan (KR); HYUN JUNG KIM, Ulsan (KR)

(21) Appl. No.: 19/082,217

(22) Filed: Mar. 18, 2025

(30) Foreign Application Priority Data
Mar. 20, 2024 (KR) 10-2024-0038232

(51) Int. Cl. G08G 1/0967; B60W 50/14

(52) U.S. Cl. CPC G08G 1/096791; B60W 50/14

(57) ABSTRACT

Embodiments relate to a method for providing alarm for flooding in an underpass including the steps of determining if a risk of flooding in the underpass will occur based on weather information, water level information and flooding velocity information in the underpass, providing guide information associated with closure of a first lane of a plurality of lanes of the underpass when it is determined that the risk of flooding will occur, and providing U-turn indication information to guide for making a U-turn from a point in the underpass into the first lane and turning back to an entrance of the underpass when it is determined that the risk of flooding will occur. According to embodiments, there is an advantage of effectively transmitting danger and guide information in the disaster situation by providing flooding-related notification to the underpass barrier and/or the road surface.

### CROSS-REFERENCE TO RELATED APPLICATION

This application claims priority to Korean Patent Application No. 10-2024-0038232, filed on Mar. 20, 2024, and all the benefits accruing therefrom under 35 U.S.C. § 119, the contents of which in its entirety are herein incorporated by reference.

### FIELD

Embodiments relate to a method for providing alarm for flooding in an underpass based on water level measurement and vehicle movement analysis, and more particularly, to a technology that guides vehicles to make U-turns and exit an underpass based on water level information and flooding velocity acquired through a water level sensor in the underpass.

### BACKGROUND

After the underpass flooding accident in Busan, closure barriers were installed in some underpasses, but there are only eleven automatic closure systems in underpasses nationwide.

In the case of the underpass in Osong where vehicles got stuck in flood water, causing large human loss and damage, even if a closure barrier had been installed and activated in the corresponding underpass, it is predicted that it would have been difficult to turn around quickly due to the material and shape of the barrier door.

That is, the current domestic underpass closure barrier systems are designed to prevent danger, so they are not good at guiding vehicles to turn around when the vehicles are in underpasses that are flooding.

Accordingly, there is a need for a barrier made of a flexible material to allow vehicles to pass through, and after the vehicles pass through it, return to the original shape to guide approaching vehicles.

### RELATED LITERATURES

### Patent Literatures

(Patent Literature 1) Korean Patent No. 10-2389354 [Applicant: Hansung Electronic Industries Co., Ltd.]

### SUMMARY

The present disclosure provides a method for providing alarm for flooding in an underpass based on water level measurement and vehicle movement analysis.

The problem to be solved by the present disclosure is not limited to the above-described problem, and may be expanded to a variety of problems that can be derived from the following embodiments of the present disclosure.

As a technical means for achieving the above-described objective, an embodiment of the present disclosure may provide a method for providing alarm for flooding in an underpass including the steps of determining if a risk of flooding in the underpass will occur based on weather information, water level information and flooding velocity information in the underpass, providing guide information associated with closure of a first lane of a plurality of lanes of the underpass when it is determined that the risk of flooding will occur, and providing U-turn indication information to guide for making a U-turn from a point in the underpass into the first lane and turning back to an entrance of the underpass when it is determined that the risk of flooding will occur.

Additionally, the method may include the steps of moving a barrier of the first lane down, displaying the guide information on the barrier of the first lane, and displaying the guide information on a road surface of the first lane.

Additionally, a display location of the guide information on the road surface of the first lane may be determined based on rainfall, vehicle movement speed and flooding velocity.

Additionally, the vehicle movement speed may be an average speed of vehicles entering the underpass.

Additionally, a distance from the entrance of the underpass to the display location of the guide information is calculated by Equation 1:

$$Distance from underpass entrance t o display location of guide information = \frac{Coefficient of proportionality \times Vehicle movement speed \times Number of vehicles in underpass}{Water level in underpass \times Rainfall}$$

Additionally, stop guide information may be provided in a stopping zone between the entrance of the underpass and the display location of the guide information to guide vehicles to stop.

Additionally, the U-turn indication information may be projected onto the road surface of the plurality of lanes of the underpass by a projector installed inside the underpass.

Additionally, when the underpass has escape stairs, a U-turn zone for U-turn to the first lane may be formed near the escape stairs.

Additionally, a distance from the entrance of the underpass to the U-turn indication information providing location is calculated by Equation 2:

$$Distance from underpass entrance to U - turn indication information providing location = \frac{Coefficient of proportionality \times Vehicle movement speed \times Number of vehicles in underpass}{Water level in underpass \times Rainfall} \qquad [ Equation 2 ]$$

Additionally, when it is determined that the risk of flooding will occur, alarm for flooding may be provided to at least one of an emergency light, a siren, a vehicle or a user terminal in the vehicle.

Additionally, when it is determined that the risk of flooding will occur, a report may be automatically transmitted to a disaster relief organization to request the control of roads near the underpass.

Additionally, the barrier may include a plurality of barrier bars extended in the length direction, the plurality of barrier bars may be made of a flexible material, the plurality of barrier bars may include a first barrier bar set corresponding to the first lane of the underpass and a second barrier bar set corresponding to the second lane of the underpass, and the plurality of barrier bars may be set to move up and down for each barrier bar set.

Additionally, the flexible material may include rubber, each of the plurality of barrier bars may be spaced a predetermined distance apart from each other, or the plurality of barrier bars may contact each other in such a way that ends of adjacent barrier bars contact each other. Additionally, each of the plurality of barrier bars may be individually rotatable, and the height to which each of the plurality of barrier bars individually moves down may be different.

Additionally, to minimize the influence of the wind, each of the plurality of barrier bars may be arranged such that the barrier curves down in a convex shape, or to minimize water accumulating on the road, each of the plurality of barrier bars may be arranged such that the barrier curves up in a convex shape.

Additionally, notification related to flood alarm may be displayed on the barrier for each barrier bar set.

Additionally, when a control server determines that the risk of flooding in the underpass will occur based on the weather information, the water level information and the flooding velocity information in the underpass, the control server may identify an autonomous driving level of a vehicle approaching the underpass and provide a different type of warning for the risk of flooding according to the identified autonomous driving level.

The underpass barrier made of a flexible material has a technical effect of guiding vehicles in the underpass to make U-turns and exit the underpass in the case where access to the underpass is restricted due to sudden heavy rain.

There is an advantage of effectively transmitting danger and guide information in the disaster situation by providing flooding-related notification to the underpass barrier and/or the road surface.

When flooding occurs, the emergency lights and sirens installed in the underpass may operate and danger warning messages may be sent to nearby vehicles' navigations and drivers/pedestrians' smartphones, and accordingly this has a beneficial effect on ensuring that drivers or pedestrians are aware of danger information in the situation where visibility is reduced by heavy rain.

It should be understood that the effects of the present disclosure are not limited to the above-described effects, and may be expanded to a variety of effects that can be derived from the following detailed description of the embodiments of the present disclosure.

### BRIEF DESCRIPTION OF THE DRAWINGS

FIG. 1 is a diagram showing an example of an operating environment of a system according to an embodiment.

FIG. 2 is a block diagram illustrating the internal configuration of a computing device according to an embodiment.

FIGS. 3A, 3B, 3C and 3D are diagrams showing examples of providing alarm for flooding in an underpass according to the relevant art.

FIG. 4 is a diagram showing an example of a barrier made of a flexible material according to an embodiment.

FIGS. 5A, 5B, 6A, 6B, 6C, 7A and 7B are diagrams showing the configuration of barrier bars according to certain embodiments.

FIG. 8 is a flowchart illustrating a method for providing alarm for flooding in an underpass according to an embodiment.

FIG. 9 is a diagram showing an example of providing guide information and U-turn indication information according to an embodiment.

FIGS. 10A and 10B are diagrams showing examples of providing alarm for flooding according to an embodiment.

FIG. 11 is a diagram showing an example of operation of a system according to an embodiment.

### DETAILED DESCRIPTION

In describing an embodiment of the present disclosure, when a certain detailed description of well-known elements or functions is determined to make the subject matter of an embodiment of the present disclosure ambiguous, the detailed description is omitted. Additionally, in the drawings, elements irrelevant to the description of an embodiment of the present disclosure are omitted, and like reference signs are affixed to like elements.

In an embodiment of the present disclosure, when an element is referred to as being “connected”, “coupled” or “linked” to another element, this may include not only a direct connection relationship but also an indirect connection relationship in which intervening elements are present. Additionally, unless expressly stated to the contrary, “comprise” or “include” when used in this specification, specifies the presence of stated elements but does not preclude the presence or addition of one or more other elements.

In an embodiment of the present disclosure, the terms “first”, “second” and the like are used to distinguish an element from another, and do not limit the order or importance between elements unless otherwise mentioned. Accordingly, a first element in an embodiment may be referred to as a second element in other element within the scope of embodiments of the present disclosure, and likewise, a second element in an embodiment may be referred to as a first element in other embodiment.

In an embodiment of the present disclosure, the distinguishable elements are intended to clearly describe the feature of each element, and do not necessarily represent the separated elements. That is, a plurality of elements may be integrated into one hardware or software, and an element may be distributed to multiple hardware or software. Accordingly, although not explicitly mentioned, the integrated or distributed embodiment is included in the scope of embodiments of the present disclosure.

In the specification, a network may be a concept including a wired network and a wireless network. In this instance, the network may refer to a communication network that allows data exchange between a device and a system and between devices, and is not limited to a particular network.

The embodiment described herein may have aspects of entirely hardware, partly hardware and partly software, or entirely software. In the specification, “unit”, “apparatus” or “system” refers to a computer related entity such as hardware, a combination of hardware and software, or software. For example, the unit, module, apparatus or system as used herein may be a process being executed, a processor, an object, an executable, a thread of execution, a program and/or a computer, but is not limited thereto. For example, both an application running on a computer and the computer may correspond to the unit, module, apparatus or system used herein.

Additionally, the device as used herein may be a mobile device such as a smartphone, a tablet PC, a wearable device and a Head Mounted Display (HMD) as well as a fixed device such as a PC or an electronic device having a display function. Additionally, for example, the device may be an automotive cluster or an Internet of Things (IoT) device. That is, the device as used herein may refer to devices on which the application can run, and is not limited to a particular type. In the following description, for convenience of description, a device on which the application runs is referred to as the device.

In the present disclosure, there is no limitation in the communication method of the network, and a connection between each element may not be made by the same network method. The network may include a communication method using a communication network (for example, a mobile communication network, a wired Internet, a wireless Internet, a broadcast network, a satellite network, etc.) as well as near-field wireless communication between devices. For example, the network may include all communication methods that enable networking between objects, and is not limited to wired communication, wireless communication, 3G, 4G, 5G, or any other methods. For example, the wired and/or wireless network may refer to a communication network by at least one communication method selected from the group consisting of Local Area Network (LAN), Metropolitan Area Network (MAN), Global System for Mobile Network (GSM), Enhanced Data GSM Environment (EDGE), High Speed Downlink Packet Access (HSDPA), Wideband Code Division Multiple Access (W-CDMA), Code Division Multiple Access (CDMA), Time Division Multiple Access (TDMA), Bluetooth, Zigbee, Wi-Fi, Voice over Internet Protocol (VOIP), LTE Advanced, IEEE802.16m, WirelessMAN-Advanced, HSPA+, 3GPP Long Term Evolution (LTE), Mobile WiMAX (IEEE 802.16e), UMB (formerly EV-DO Rev. C), Flash-OFDM, iBurst and MBWA (IEEE 802.20) systems, HIPERMAN, Beam-Division Multiple Access (BDMA), World Interoperability for Microwave Access (Wi-MAX) or communication using ultrasonic waves, but is not limited thereto.

The elements described in a variety of embodiments are not necessarily essential, and some elements may be optional. Accordingly, an embodiment including some of the elements described in the embodiment is also included in the scope of embodiments of the present disclosure. Additionally, in addition to the elements described in a variety of embodiments, an embodiment further including other elements is also included in the scope of embodiments of the present disclosure.

Hereinafter, embodiments of the present disclosure will be described in detail with reference to the accompanying drawings.

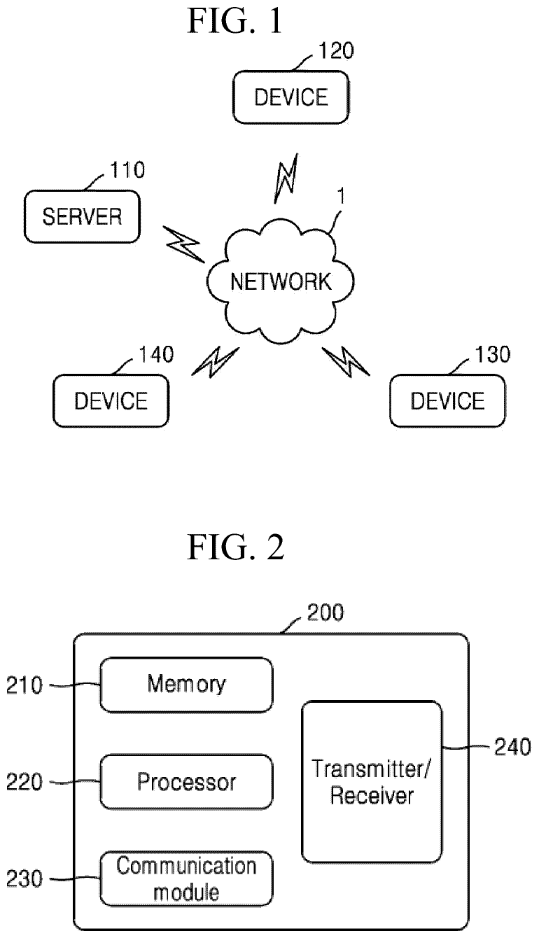

FIG. 1 is a diagram showing an example of a working environment of a system according to an embodiment of the present disclosure. Referring to FIG. 1, a user device 110 and one or more servers 120, 130, 140 are connected via a network 1. FIG. 1 is provided by way of example, and the number of user devices or servers is not limited thereto.

The user device 110 may be a fixed or mobile terminal implemented as a computer system. The user device 110 may include, for example, a smart phone, a mobile phone, a navigation, a computer, a laptop computer, a digital broadcasting terminal, a Personal Digital Assistant (PDA), a Portable Multimedia Player (PMP), a tablet PC, a game console, a wearable device, an internet of things (IoT) device, a virtual reality (VR) device and an augmented reality (AR) device. For example, in the embodiments, the user device 110 may refer to, in substance, one of a variety of physical computer systems that can communicate with the servers 120-140 via the network 1 using a wireless or wired communication method.

Each server may be implemented as a computer device or a plurality of computer devices which provide instructions, code, files, content and services by communication with the user device 110 via the network 1. For example, the server may be a system which provides each service to the user device 110 connected via the network 1. As a more specific example, through an application as a computer program installed and running on the user device 110, the server may provide the user device 110 with a service (for example, information provision, etc.) intended by the corresponding application. As another example, the server may distribute files for installing and running the above-described application to the user device 110, receive user input information and provide a corresponding service.

FIG. 2 is a block diagram illustrating the internal configuration of a computing device 200 in an embodiment of the present disclosure. The computing device 200 may be applied to the user device 110 or the servers 120-140 described above with reference to FIG. 1, and each device and the servers may have identical or similar internal configuration by adding or subtracting some components.

Referring to FIG. 2, the computing device 200 may include a memory 210, a processor 220, a communication module 230 and a transmitter/receiver 240. The memory 210 is a non-transitory computer-readable recording medium, and may include a permanent mass storage device such as random access memory (RAM), read only memory (ROM), disk drive, solid state drive (SSD) and flash memory. Here, the permanent mass storage device such as ROM, SSD, flash memory and disk drive is a separate permanent storage device that is different from the memory 210 and may be included in the above-described device or server. Additionally, the memory 210 may store an operating system and at least one program code (for example, code for browsers installed and running on the user device 110 or applications installed on the user device 110 to provide particular services). These software components may be loaded from a separate computer-readable recording medium that is different from the memory 210. The separate computer-readable recording medium may include a computer-readable recording medium such as floppy drive, disk, tape, DVD/CD-ROM drive and a memory card.

In another embodiment, the software components may be loaded onto the memory 210 through the communication module 230, but not the computer-readable recording medium. For example, at least one program may be loaded onto the memory 210 based on a computer program (for example, the above-described application) installed by files provided by developers or a file distribution system (for example, the above-described server) responsible for distributing an installation file of the application via the network 1.

The processor 220 may be configured to process the instructions of the computer program by performing basic operations such as arithmetic, logic and input/output operations. The instructions may be provided to the processor 220 by the memory 210 or the communication module 230. For example, the processor 220 may be configured to execute the received instructions according to the program code stored in the recording device such as the memory 210.

The communication module 230 may provide a function of allowing the user device 110 and the servers 120-140 to communicate with each other via the network 1, and a function of allowing each of the device 110 and/or the servers 120-140 to communicate with another electronic device.

The transmitter/receiver 240 may be a means for interfacing with an external input/output device (not shown). For example, the external input device may include a keyboard, a mouse, a microphone and a camera, and the external output device may include a display, a speaker and a haptic feedback device.

As another example, the transmitter/receiver 240 may be a means for interfacing with a device having an integrated function for input and output such as a touchscreen.

Additionally, in other embodiments, the computing device 200 may include a larger number of components than the components of FIG. 2 according to the nature of a device to which the computing device 200 is applied. For example, when the computing device 200 is applied to the user device 110, the computing device 200 may be implemented to include at least some of the above-described input/output devices, or may further include other components such as a transceiver, a Global Navigation Satellite System (GNSS) module, a camera, a variety of sensors and a database. As a more specific example, when the user device is a smartphone, the computing device 200 may be implemented to further include various types of components commonly included in smartphones, such as an acceleration sensor or a gyro sensor, a camera module, a variety of physical buttons, buttons using a touch panel, input/output ports and a vibrator for vibration.

The computing device 200 described above may be realized by a device including a processor and a memory. The memory may store instructions, and the processor may perform the operations described hereinafter based on the instructions stored in the memory. The device according to the present disclosure may be implemented by at least a part of the configuration illustrated in FIG. 1 or FIG. 2.

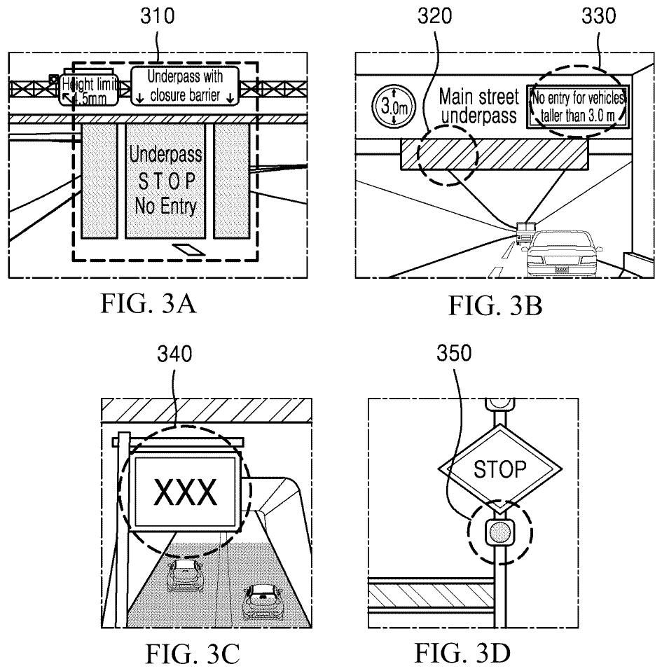

FIG. 3 is a diagram showing an example of providing alarm for flooding in an underpass according to the relevant art.

FIG. 3(A) shows a closure underpass barrier 310 made of fabric in South Korea. FIG. 3(B) shows an underpass barrier door 320 made of a steel plate in South Korea where an electric sign 330 is installed to notify no entry information.

FIG. 3(C) shows an underpass electric sign 340 in Japan, notifying that passing is prohibited. FIG. 3(D) shows a flashing underpass light 350 in UK, and the flashing light 350 indicates that the underpass is not accessible.

As shown in FIG. 3(A) and FIG. 3(B), the existing domestic underpass closure barrier systems are designed to prevent danger, so they are not good at guiding vehicles to turn around when the vehicles are in underpasses that are flooding.

In addition, as shown in FIG. 3(C) and FIG. 3(D), overseas underpass flooding alarm systems provide visual information, but it is not enough to effectively notify dangerous situations when visibility is reduced by heavy rain.

To solve this problem, an embodiment of the present disclosure provides an underpass barrier made of a flexible material to allow vehicles in the underpass to make U-turns and exit the underpass when access is restricted in case of sudden heavy rain.

In addition, an embodiment of the present disclosure has an advantage of providing flooding-related notification as visual and auditory information to underpass barriers, road surfaces, emergency lights, sirens, nearby vehicles' navigations, drivers/pedestrians' smartphones and/or disaster relief organizations, thereby effectively notifying danger and guide information in many ways in disaster situations.

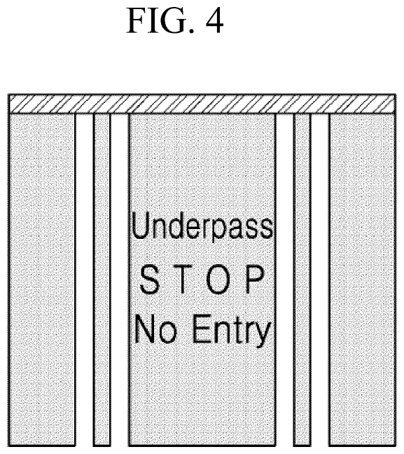

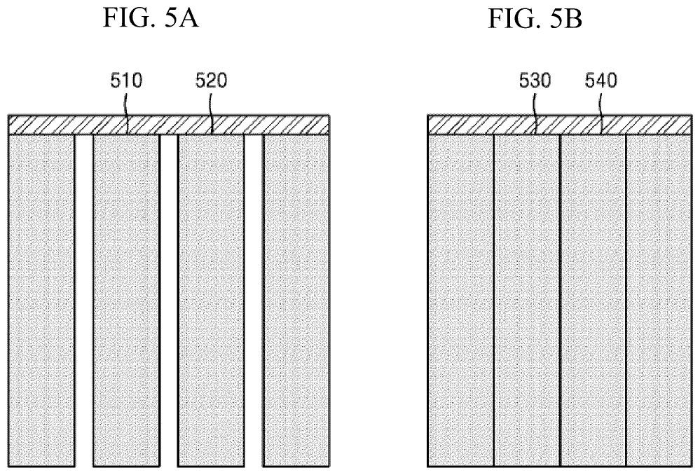

FIG. 4 is a diagram showing an example of the barrier made of the flexible material according to an embodiment.

As shown in FIG. 4, the barrier may include a plurality of barrier bars extended in the length direction. In addition, the plurality of barrier bars may be made of a flexible material such as rubber. The barrier made of the flexible material may be less affected by the wind than the existing planar barriers. Accordingly, the barrier may allow vehicles to pass through, and after vehicles pass through the barrier, return to the original shape quickly. For example, the plurality of barrier bars may form a barrier bar set corresponding to each lane, and accordingly, different information may be displayed for each barrier bar set. Each barrier bar set may move up or down. For example, in the case of the underpass with two or more lanes, the barrier bar set may be equipped for each lane, and when blocking the first lane and not blocking the second lane, only the barrier bar set in the first lane may move down.

As shown in FIG. 4, a text such as No Entry may be printed and displayed on the barrier, and various information may be dynamically projected onto the barrier by a projector installed inside or outside the underpass. The projector may be installed inside/outside the underpass to display the information on two sides of the barrier. For example, because traffic jams in the underpass increase the risk of collisions, a guidance image may be projected onto the inner side of the barrier in the underpass. In this instance, the zoom of the guidance image may be adjusted as needed.

According to an embodiment, as the barrier is made of the flexible material, the barrier returns to the original shape quickly after vehicles pass through the barrier and displays information to approaching vehicles.

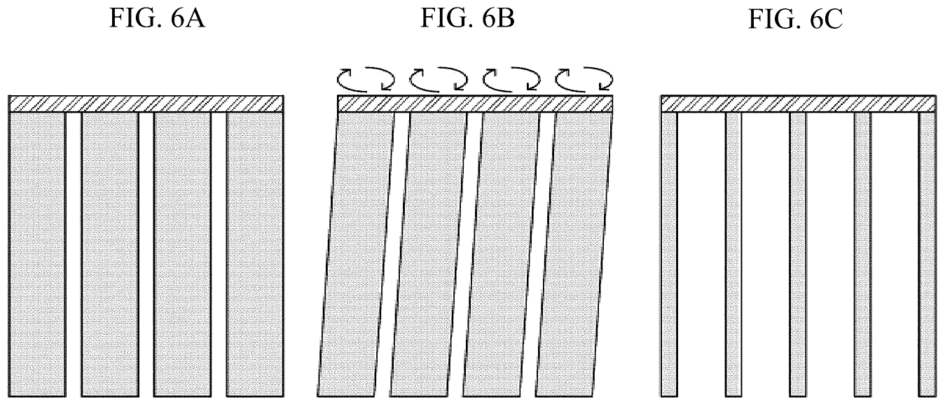

FIGS. 5 to 7 are diagrams showing the configuration of the barrier bars according to certain embodiments.

As shown in FIG. 5(A), each of the plurality of barrier bars of the barrier may be spaced a predetermined distance apart from each other. In contrast, as shown in FIG. 5(B), the plurality of barrier bars of the barrier may contact each other in such a way that ends of adjacent barrier bars contact each other. For example, the first barrier bar 510 and the second barrier bar 520 may be spaced the predetermined distance apart from each other, while the third barrier bar 530 and the fourth barrier bar 540 may contact each other in such a way that the right end of the third barrier bar 530 and the left end of the fourth barrier bar 540 contact each other without a gap between them. Although FIG. 5(A) shows the same interval between the plurality of barrier bars, it will be easily understood by those skilled in the art that the interval between the barrier bars may be different when necessary. In some cases, the barrier may include both barrier bars spaced apart from each other and barrier bars in contact with each other.

As shown in FIG. 6(B), each of the plurality of barrier bars may be individually rotatable. It will be easily understood by those skilled in the art that the rotation angle of each of the barrier bars may be different from each other depending on circumstances.

In an example, the interval between the barrier bars and the rotation angle of each barrier bar may be individually adjusted. For example, the interval between the barrier bars and the rotation angle may be determined according to the direction of the wind. When the barrier bars are blown by the wind, the image displayed on the barrier bar set may not be clearly visible to drivers. Accordingly, the interval between the barrier bars and the rotation angle according to an embodiment of the present disclosure may be adjusted to minimize the movement by the wind. For example, when the wind blows at an angle of 45° forward, each barrier bar may rotate 45° to minimize the shape change of the barrier bars, and in this instance, the shape of the projection image of the projector may be adjusted according to the current position and angle of the barrier bars to maintain the image displayed on the barrier bar set.

The barrier shown in FIG. 6(C) is the result of rotating each of the barrier bars of the barrier shown in FIG. 6(A) by 90°. When each of the plurality of barrier bars is rotated by 90° as shown in FIG. 6(C), the inside of the underpass is clearly visible from the outside of the underpass, which makes it easier to keep vehicles moving, and thus the rotation angle of each of the plurality of barrier bars may be adjusted according to the risk level of flooding.

In an example, the height to which each of the plurality of barrier bars individually moves down may be different. That is, when moving the barrier down, the length of downward movement may be different for each barrier bar, so the barrier bars may be arranged in a curved shape rather than a straight line shape.

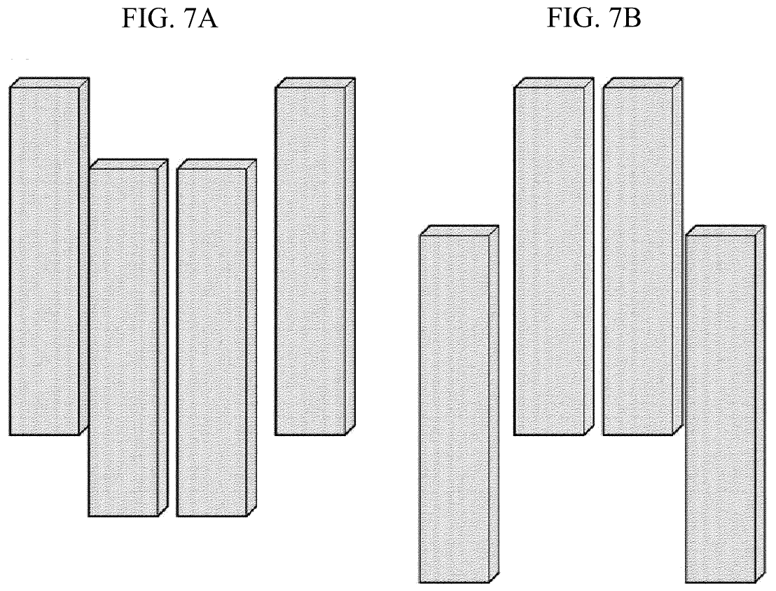

In an embodiment, when moving the barrier down to restrict the access to the underpass, each of the plurality of barrier bars may be arranged such that the barrier curves down in a convex shape as shown in FIG. 7(A) to minimize the influence of the wind. Because the wind blows from the inside of the underpass to the outside, the barrier of this shape is designed to be less affected by the wind. In another embodiment, each of the plurality of barrier bars may be arranged such that the barrier curves up in a convex shape as shown in FIG. 7(B) to minimize water accumulating on the road. When the barrier bars are arranged in the shape shown in FIG. 7(B), there is an advantage of allowing water at the bottom of the barrier bars to flow down to two ends of the barrier during heavy rain, thereby effectively reducing water on the road where vehicles pass.

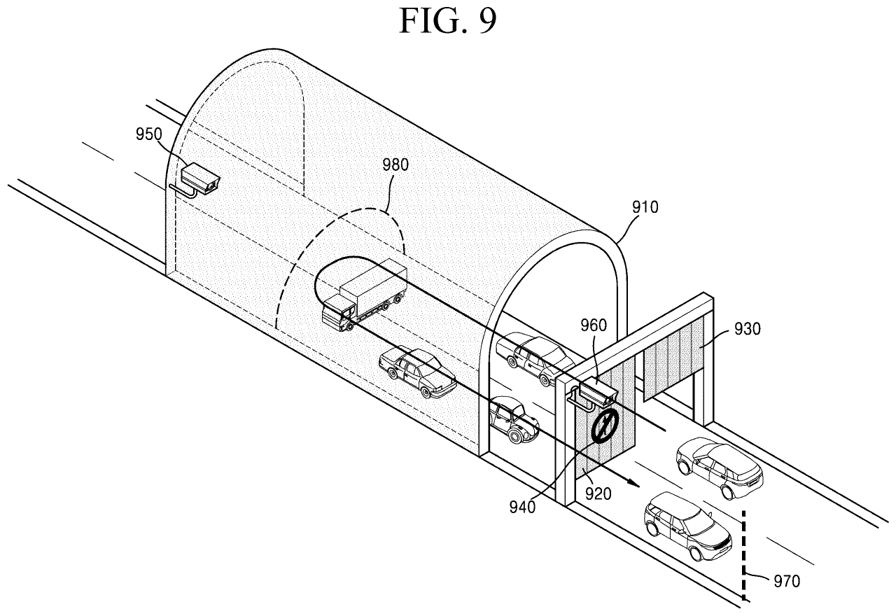

Additionally, notification related to flood alarm may be displayed on the barrier for each barrier bar set, and its related example will be described in FIG. 9 below.

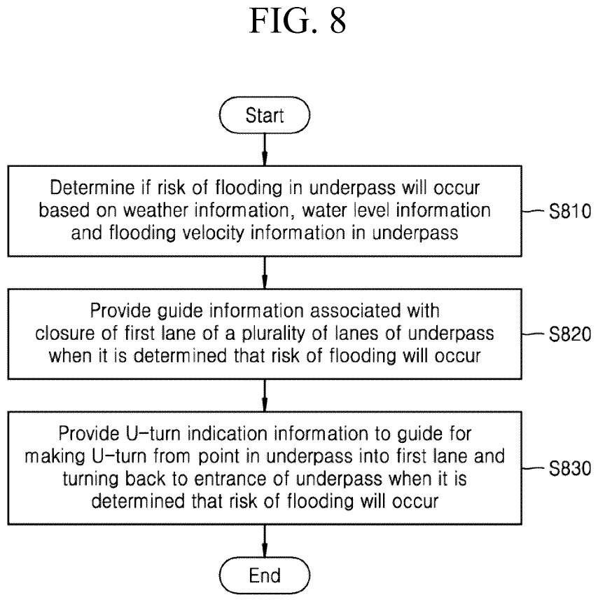

FIG. 8 is a flowchart illustrating a method for providing alarm for flooding in the underpass according to an embodiment.

In step S810, determination may be made as to whether the risk of flooding in the underpass will occur based on weather information, water level information and flooding velocity information in the underpass. In an embodiment, a sensor unit in the underpass may include a camera, a water level sensor, an acceleration sensor or an infrared sensor to acquire various sensing information, and a control server may receive the sensor information and determine if the risk of flooding will occur based on the sensor information.

In step S820, when it is determined that the risk of flooding will occur, guide information associated with the closure of the first lane of the plurality of lanes of the underpass may be provided. In an embodiment, the barrier of the first lane may move down, and the guide information may be displayed on the barrier of the first lane. In addition, the guide information may be displayed on the road surface of the first lane. The display location of the guide information on the road surface of the first lane may be determined based on rainfall, vehicle movement speed and flooding velocity. In this instance, the vehicle movement speed may be the average speed of vehicles entering the underpass.

Additionally, stop guide information may be provided in the stopping zone between the entrance of the underpass and the display location of the guide information to guide vehicles to stop.

An example of providing the guide information will be described in detail in FIG. 9 below.

In step S830, when it is determined that the risk of flooding will occur, U-turn indication information may be provided to guide vehicles to make U-turns from a point in the underpass into the first lane and turn back to the entrance of the underpass.

In an embodiment, the U-turn indication information may be projected onto the road surface of the plurality of lanes of the underpass by the projector installed inside the underpass. The projector may be installed inside and/or outside the underpass to project and display various information on the road surface of the lanes. In addition, when the underpass has escape stairs, a U-turn zone for U-turn to the first lane may be formed near the escape stairs.

An example of providing the U-turn indication information is described in detail in FIG. 9 below.

After the step S830, when it is determined that the risk of flooding will occur, an alarm for flooding may be provided to at least one of the emergency light, the siren, the vehicle or the user terminal in the vehicle. In addition to the alarm, a report may be automatically transmitted to the disaster relief organization to request the control of roads near the underpass.

FIG. 9 is a diagram showing the example of providing the guide information and the U-turn indication information according to an embodiment.

When it is determined that the risk of flooding will occur, the guide information associated with the closure of the first lane of the plurality of lanes of the underpass may be provided as shown in FIG. 9. The barrier may include a first barrier bar set 920 corresponding to the first lane and a second barrier bar set 930 corresponding to the second lane. The first barrier bar set 920 of the barrier may move down, and the guide information 940 may be displayed on the first barrier bar set. The guide information such as No Entry may be printed for each barrier bar set, or various information may be dynamically projected onto the barrier bar set by the nearby projectors 950, 960.

In addition, the guide information 970 may be displayed on the road surface of the first lane. Road traffic cones may be visualized and displayed on the road surface by the projection of the projector 960 installed outside the underpass. In addition, a text such as “No Road” or

“Road Narrows” may be displayed on the road surface. For example, as shown in FIG. 9, a guide line that prohibits passing in the first lane of the underpass may be projected onto the road surface of the first lane as the guide information 970. Accordingly, vehicles entering the underpass may change the lane from the first lane to the second lane and pass through the entrance 910 of the underpass.

In an embodiment, the display location of the guide information 970 on the road surface of the first lane may be determined based on rainfall, vehicle movement speed and flooding velocity. In this instance, the vehicle movement speed may be the average speed of vehicles entering the underpass. The flooding velocity may be the average flooding velocity of vehicles in the underpass.

Additionally, the distance from the entrance 910 of the underpass to the display location of the guide information 970 on the road surface may be calculated by Equation 1.

$$Distance from underpass entrance to display location of guide information = \frac{Coefficient of proportionality \times Ve hicle movement speed \times Number of vehicles in underpass}{Water level in underpass \times Rainfall} \qquad [ Equation 1 ]$$

Additionally, the stop guide information may be provided in the stopping zone between the entrance 910 of the underpass and the display location of the guide information 970 to guide vehicles to stop. For example, the stopping zone is the area indicated by the arrow between the entrance 910 of the underpass and the first barrier bar set 920 as shown in FIG. 9, and the stop guide information may be projected onto the side of the first barrier bar set 920 toward the entrance 910 of the underpass. Because traffic jams increase the risk of collisions, the zoom of the stop guide information on the inner side may be adjusted as needed.

In an embodiment, the underpass barrier is made of the flexible material to allow vehicles in the underpass to make U-turns and exit the underpass when some lanes of the underpass are blocked due to sudden heavy rain. In an embodiment, the U-turn indication information 980 may be provided to guide vehicles to make U-turns from a proper point in the underpass into the first lane and turn back to the entrance 910 of the underpass. The U-turn indication information may include the guide line 980 as shown in FIG. 9, or a real barrier may be installed and provided.

In an embodiment, the U-turn indication information may be projected onto the road surface of the plurality of lanes of the underpass by the projector 950 installed inside the underpass. The projector may be installed inside and/or outside the underpass to project and display various information on the road surface of the lanes. In addition, when the underpass has escape stairs, the U-turn zone for U-turn to the first lane may be formed near the escape stairs.

Additionally, the distance from the entrance 910 of the underpass to the U-turn indication information 980 providing location may be calculated by Equation 2.

$$Distance from underpass entrance to U - turn indication information providing location = \frac{Coefficient of proportionality \times Vehicle movement speed \times Number of vehicles in underpass}{Water level in underpass \times Rainfall} \qquad [ Equation 2 ]$$

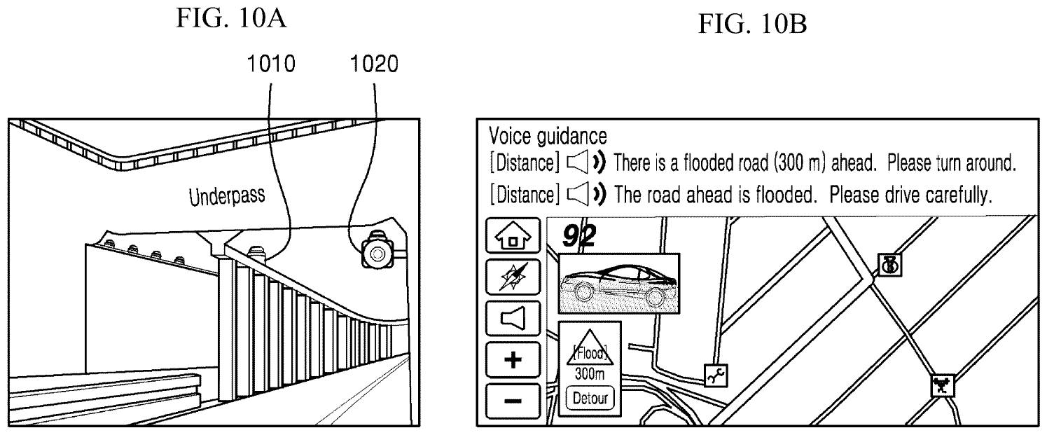

FIG. 10 is a diagram showing an example of providing alarm for flooding according to an embodiment.

Because heavy rain that causes flooding in the underpass reduces driving vision, it is difficult to effectively notify dangerous situations despite the guide information displayed on the electric sign. Accordingly, as shown in FIG. 10(A), when it is determined that the risk of flooding will occur by the water level sensor in the underpass, the emergency light 1010 installed in the underpass may flash and the siren 1020 may operate to provide alarm for flooding as visual and auditory information to vehicles passing through the underpass.

As shown in FIG. 10(B), flooding-related notification may be transmitted as image and voice to the navigations of vehicles that are supposed to pass through the underpass or located at a danger zone within a preset radius of the underpass. In an embodiment, a flood photo image may be displayed on the navigation of the vehicle, and words such as Flooding ahead or Detour may be guided through the navigation voice. For example, when there is a flooded road 300 m ahead, a message “There is a flooded road 300 m ahead. Please turn around” may be guided through the navigation voice. In addition, immediately before entering the flooded road, a message “The road ahead is flooded. Please drive carefully” may be guided through the navigation voice.

In addition, when it is determined that the risk of flooding will occur, a disaster text message related to flooding may be sent from the disaster relief organization to the terminals of vehicle drivers, passengers and/or pedestrians located at the danger zone within the preset radius of the underpass. In addition, roads near the underpass may be restricted by the support of the disaster relief organization. As described above, an embodiment of the present disclosure has an advantage of effectively notifying danger and guide information in various ways in the disaster situation.

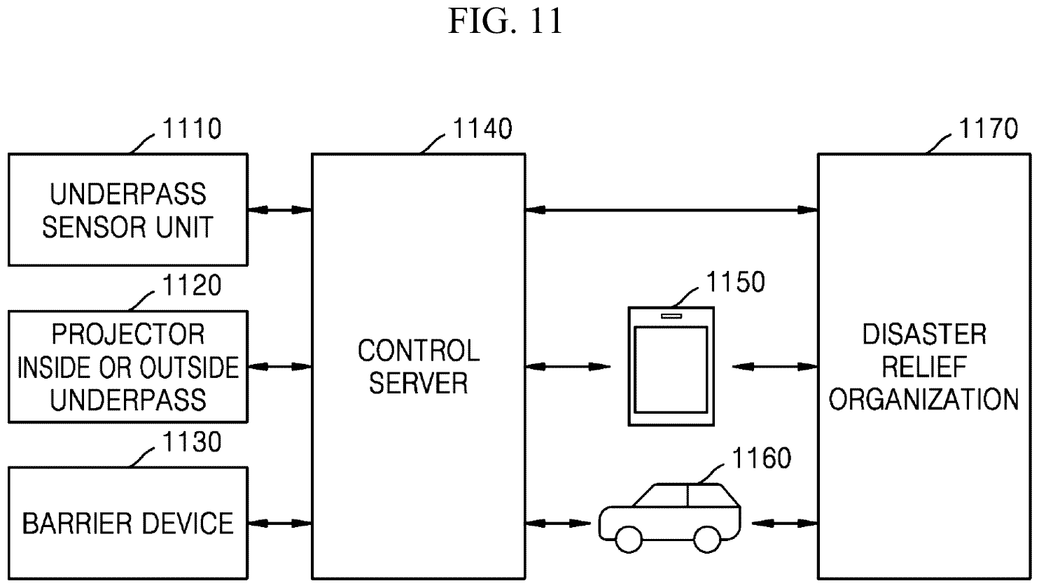

FIG. 11 is a diagram showing an example of operation of a system according to an embodiment.

The system for providing alarm for flooding in the underpass may include the sensor unit 1110 in the underpass, the projector 1120 inside or outside the underpass, the underpass barrier device 1130, the control server 1140, the terminal 1150 of the driver/passenger/pedestrian, the vehicle 1160 and the disaster relief organization 1170.

In an embodiment, the sensor unit 1110 in the underpass may include a camera, a water level sensor, an acceleration sensor and an infrared sensor to acquire various sensing information and the sensing information may be transmitted to the control server 1140.

The projector 1120 installed inside or outside the underpass may project various information onto the barrier device or the road surface to provide notification related to flood alarm as described above.

The barrier device 1130 may include the barrier and the barrier bar set as described above.

The control server 1140 may generally control the overall operation of the system. The control server 1140 may communicate with the sensor unit 1110 in the underpass, the projector 1120 inside or outside the underpass, the underpass barrier device 1130, the terminal 1150 of the driver/passenger/pedestrian, the vehicle 1160 and the disaster relief organization 1170 via a network.

The control server 1140 may receive the sensing information from the sensor unit 1110 in the underpass and determine if the risk of flooding will occur based on the sensing information. For example, the control server 1140 may determine if the risk of flooding in the underpass will occur based on weather information, water level information and flooding velocity information in the underpass. When it is determined that the risk of flooding will occur, the control server 1140 may transmit a command to the barrier device 1130 to move the barrier down to block the underpass. In addition, the control server 1140 may transmit a command to the projector 1120 to provide notification related to the risk of flooding.

In addition, when it is determined that the risk of flooding will occur, the control server 1140 may provide alarm for flooding to at least one of the emergency light, the siren, the vehicle 1160 or the user terminal 1150 in the vehicle, and automatically transmit a report to the disaster relief organization 1170 such as 119 to request the control of roads near the underpass.

In addition, the disaster relief organization 1170 may send a disaster text message related to flooding to the terminal 1150 of vehicle driver, passenger and/or pedestrian located at the danger zone within the preset radius of the underpass.

Moreover, when a switchboard is submerged and fails to operate, the risk of flooding drastically increases, so a control station or a pump station may be designed using fiber-reinforced polymer having high resistance to corrosive contaminants in the outer surface of the switchboard. Through this, it may be possible to reduce the risk of flooding in communication network servers or emergency call response network servers.

In addition, in an example, the control server 1140 may differently provide a warning of flood risk depending on autonomous driving level of a vehicle entering the underpass. For example, when a first vehicle having Level 2 autonomous driving approaches the underpass and a vehicle having Level 3 autonomous driving is behind the first vehicle, a warning for the dangerous situation may be provided to the first vehicle in a visual or auditory form that is easy for humans to perceive, and a virtual dangerous situation object may be created for the second vehicle in the sensing range of the second vehicle to allow the sensors for the autonomous driving system to perceive the warning situation. For example, an image of torrent flow may be projected in front of the second vehicle. Meanwhile, this is provided for illustration purposes, and when the autonomous driving level is 3 or higher, the dangerous situation may be provided to the vehicle via Vehicle-to-Everything (V2X) communication for the system's danger identification rather than human perception.

That is, according to an embodiment of the present disclosure, when the first vehicle and the second vehicle enter the underpass, different types of warning information may be generated for the first vehicle and the second vehicle. Meanwhile, in an embodiment, when the vehicle having Level 3 autonomous driving enters the underpass that is at risk of flooding, the control server 1140 may guide the vehicle driver to intervene in the vehicle.

Meanwhile, visual and auditory warnings for humans may be less effective for vehicles having Level 4 or 5 autonomous driving, so visual and auditory warnings may be provided to other vehicles having Levels 0 to 3 autonomous driving in front and behind the vehicles of the corresponding level. That is, when providing visual and auditory warnings through a predetermined number of projectors or speakers, visual and auditory warnings may be provided more intensively to vehicles of other levels except vehicles having Levels 4 and 5.

In this specification, Level 2 autonomous driving represents that the human and the system take control and the human is responsible for driving, and Level 3 represents that the system takes control and is responsible for driving, and the driver intervenes under certain conditions. In addition, Levels 4 and 5 autonomous driving represent that driver intervention is useless or the driver is not required.

In FIG. 11, the operation of the system is described with different names from those of FIG. 1 for the purpose of convenience, but the control server 1140 and the disaster relief organization 1170 in FIG. 11 may be the server 110 in FIG. 1, and the sensor unit 1110 in the underpass, the projector 1120 inside or outside the underpass, the underpass barrier device 1130, the driver/passenger/pedestrian's terminal 1150, and the vehicle 1160 in FIG. 11 may be the devices 120 to 140 in FIG. 1.

The embodiments described hereinabove may be implemented, at least in part, as a computer program and recorded in a computer-readable recording medium. The computer-readable recording medium for recording the program for implementing the embodiments includes any type of recording device in which computer-readable data is stored. Examples of the computer-readable recording medium include ROM, RAM, CD-ROM, magnetic tape or optical data storage devices. In addition, the computer-readable recording medium may be distributed over computer systems connected via a network, to store and execute computer-readable codes in a distributed fashion. In addition, functional programs, codes and code segments for implementing the embodiments will be easily understood by persons having ordinary skill in the technical field pertaining to the embodiments.

While the present disclosure has been hereinabove described with reference to the embodiments shown in the drawings, this is provided for illustrative purposes only and it will be appreciated by those having ordinary skill in the art that various modifications and variations may be made thereto. However, it should be noted that such modifications fall in the technical protection scope of the present disclosure. Therefore, the true technical protection scope of the present disclosure should be defined as including other embodiments and other examples by the technical spirit of the appended claims and the equivalents to the appended claims.

What is claimed is:

1. A method for providing alarm for flooding in an underpass, performed by a computing device, the method comprising the steps of:
determining if a risk of flooding in the underpass will occur based on weather information, water level information and flooding velocity information in the underpass;
providing guide information associated with closure of a first lane of a plurality of lanes of the underpass when it is determined that the risk of flooding will occur; and
providing U-turn indication information to guide for making a U-turn from a point in the underpass into the first lane and turning back to an entrance of the underpass when it is determined that the risk of flooding will occur,
wherein when it is determined that the risk of flooding in the underpass will occur based on the weather information, the water level information and the flooding velocity information in the underpass, the computing device identifies an autonomous driving level of each vehicle approaching the underpass and provides a warning for the risk of flooding in a different form to each of the vehicles sequentially entering the underpass according to the identified autonomous driving level,
wherein the computing device provides a first warning in a visual and auditory form that is perceivable by a human when the autonomous driving level of the vehicle is a first range, and provides a second warning to allow a system of the vehicle to identify danger via V2X communication when the autonomous driving level of the vehicle is a second range,
wherein the first range does not overlap the second range, and the first range is a range in which human driving is required and the second range is a range in which human driving is useless,
wherein in the first range, as the autonomous driving level is closer to the second range, the visual and auditory form of the warning becomes less, and
wherein the second warning includes a guide to driver intervention in the vehicle.

2. The method according to claim 1,
wherein the step of providing the guide information comprises the steps of:
moving the barrier of the first lane down; and
displaying the guide information on the barrier of the first lane.

3. The method according to claim 2, further comprising the step of:
displaying the guide information on a road surface of the first lane,
wherein a display location of the guide information on the road surface of the first lane is determined based on rainfall, vehicle movement speed and flooding velocity.

4. The method according to claim 3,
wherein the vehicle movement speed is an average speed of vehicles entering the underpass.

5. The method according to claim 3,
wherein a distance from the entrance of the underpass to the display location of the guide information is calculated by Equation 1:
$$Distance from underpass entrance to display location of guide information = \frac{Coefficient of proportionality \times Vehicle movement speed \times Number of vehicles in underpass}{Water level in underpass \times Rainfall}$$
